(19) United States
(12) Patent Application Publication
(10) Pub. No.: US 2016/0269501 A1
(43) Pub. Date: Sep. 15, 2016

(54) USING A CACHE CLUSTER OF A CLOUD COMPUTING SERVICE AS A VICTIM CACHE

(71) Applicant: NetApp, Inc., Sunnyvale, CA (US)

(72) Inventors: Ameya Prakash Usgaonkar, Old Goa (IN); Bhaskar Singhal, Bangalore (IN)

(21) Appl. No.: 14/644,907

(22) Filed: Mar. 11, 2015

(51) Int. Cl. H04L 29/08; H04L 29/06

(52) U.S. Cl. CPC H04L 67/2842; H04L 67/42

(57) ABSTRACT

Technology is disclosed for using a cache cluster of a cloud computing service (“cloud”) as a victim cache for a data storage appliance (“appliance”) implemented in the cloud. The cloud includes a cache cluster that acts as a primary cache for caching data of various services implemented in the cloud. By using the cache cluster as a victim cache for the appliance, the read throughput of the appliance is improved. The data blocks evicted from a primary cache of the appliance are stored in the cache cluster. These evicted data blocks are likely to be requested again, so storing them in the cache cluster can increase performance, e.g., input-output (I/O) throughput of the appliance. A read request for data can be serviced by retrieving the data from the cache cluster instead of a persistent storage medium of the appliance, which has higher read latency than the cache cluster.

### TECHNICAL FIELD

Several of the disclosed embodiments relate to cloud computing service based data storage services, and more particularly, to using a cache cluster of the cloud computing service as a victim cache for the data storage services.

### BACKGROUND

With the advent of cloud computing services, more and more enterprises are looking to deploy their applications in this comparatively cheaper cloud environment. A cloud computing service (“cloud”) can be a distributed computing system that provides various hardware and software resources for implementing a variety of applications that provide a variety of services. For example, the cloud can provide the necessary hardware and software for implementing a data storage appliance that provides data management services to a user.

Storage appliances can be executed as virtual storage appliances (VSAs) in the cloud. The purpose of such storage appliances running in the cloud is to extend their current offerings to cloud or provide services for data management to cloud-based use cases. The VSA is configured as a virtual machine on a hypervisor which in turn runs on a computing device in the cloud and this VSA uses block storage from cloud to store data. Typically, the block storage offering in the cloud is not fast enough for all types of applications running on the cloud. Further, many storage appliances can be optimized for write and therefore, the low performing offering of the cloud can adversely affect client read latency. Finally, a public cloud does not provide dedicated hardware and as a result, typical caching solutions of storage appliances are rendered non-functional in public cloud.

In cloud environments, the VSA's input-output (I/O) throughput, latency and input-output operations (IOPs) can be directly dependent on the performance service level agreements (SLA's) of the storage used by the VSA. For example, the throughput, latency and IOPs of an application using the storage provided by the VSA in the cloud will depend on the performance SLAs exported by the cloud hosting the VSA. Some applications may desire low latency and higher IOPs at certain times. To satisfy such requirements, changing the SLA of storage used by the VSA may not be feasible.

### BRIEF DESCRIPTION OF THE DRAWINGS

FIG. 1 is a block diagram illustrating an environment in which the disclosed embodiments of a data storage appliance can be implemented.

FIG. 2 is a block diagram illustrating an example of processing a read request using the data storage appliance of FIG. 1, consistent with various embodiments.

FIG. 3 is a block diagram of an architecture of a data storage appliance implemented in a cloud computing service (“cloud”) of FIG. 1, consistent with various embodiments.

FIGS. 4A and 4B are block diagrams illustrating a process of data eviction in the data storage appliance of FIG. 1, consistent with various embodiments.

FIG. 5 is a block diagram of the data storage appliance of FIG. 1, consistent with various embodiments.

FIG. 6 is a flow diagram a process of writing data to the data storage appliance implemented in a cloud of FIG. 1, consistent with various embodiments.

FIG. 7 is a flow diagram of a process for evicting data from a primary cache to a victim cache of a data storage appliance in the cloud of FIG. 1, consistent with various embodiments.

FIG. 8 is a flow diagram of a process for reading data from the data storage appliance in the cloud of FIG. 1, consistent with various embodiments.

FIG. 9 is a block diagram of a computer system as may be used to implement features of some embodiments of the disclosed technology.

### DETAILED DESCRIPTION

Technology is disclosed for using a cache cluster of a cloud computing service as a victim cache for a data storage appliance implemented in the cloud computing service (referred to as “cloud”). The data storage appliance is a storage service implemented in the cloud for providing data storage services. The cloud includes a cache cluster, which is a collection of one or more cache computing nodes (referred to as “cache nodes”), that acts as a primary cache for caching data of various services implemented in the cloud. For example, for a video streaming service implemented in the cloud, the cache cluster can cache some frequently requested videos. When a request for a particular video is received, if the particular video is cached at the cache cluster, the video is streamed from the cache cluster, else the video is obtained from a persistent storage device associated with the video streaming service.

The technology facilitates using the cache cluster of the cloud as a victim cache for the data storage appliance. In some embodiments, a victim cache is an extension to a primary cache of the data storage appliance that acts as a secondary cache to store data blocks that have been evicted from the primary cache, e.g., due to a capacity. These evicted data blocks are likely to be requested again so storing them in the secondary cache can increase performance, e.g., input-output (I/O) throughput of the data storage appliance.

The data storage appliance includes a primary cache that can be used to cache data written to or read from the data storage appliance, e.g., by an application executing at a client computing device (referred to as “client”). The cache cluster of the cloud acts as the victim cache to serve the read requests when the data is not available in the primary cache. When a set of data is written to the data storage appliance, the data storage appliance writes the set of data in the primary cache of the data storage appliance and marks the data as “dirty” indicating that the set of data is not yet stored at a persistent storage device associated with the data storage appliance. When the set of data is flushed from the primary cache to the persistent storage device, e.g., upon a trigger condition, the set of data can be written to the persistent storage device and marked as “clean” in the primary cache.

When the data is evicted from the primary cache, e.g., to write new data that is being input by the client, the data storage appliance evicts the clean data from the primary cache to the victim cache, that is, the cache cluster of the cloud. The cache cluster of the cloud stores the evicted data and can be used for serving future read requests from the client. When a read request arrives at the data storage appliance, the data storage appliance can determine whether the requested data is available at the primary cache and if it is marked as clean. If the requested data is unavailable at the primary cache or if it is available but not marked as clean, the data storage appliance can retrieve the requested data from the victim cache. If the requested is not available at the victim cache, the data storage appliance can then retrieve the requested data from the persistent storage device.

In some embodiments, retrieving the data from the victim cache can be faster than retrieving the data from the persistent storage device. Accordingly, by facilitating the use of cache cluster of the cloud as the victim cache of the data storage appliance, the technology improves the performance of the data storage appliance in serving a read request from the client, e.g., by decreasing the time consumed in retrieving data from the data storage appliance. Typically, the persistent storage device of the data storage appliance include storage media that have lower I/O throughput, higher read latency than storage media of the cache cluster. In some embodiments, the persistent storage device of the data storage appliance can include storage media such as hard disk drives, magnetic tapes, optical disks such as CD-ROM or DVD-based storage, magneto-optical (MO) storage, or any other type of non-volatile storage devices suitable for storing large quantities of data. In some embodiments, the cache cluster can include flash-based storage devices such as solid state drives (SSDs), non-volatile, solid-state NAND flash devices which are block-oriented devices having good (random) read performance, i.e., read operations to flash devices are substantially faster than write operations. In some embodiments, the primary cache of the data storage appliance includes random access memory (RAM) based storage media such as dynamic RAM (DRAM).

In some embodiments, the data storage appliance is implemented as a virtual storage server in the cloud. The virtual storage server can be executed on a hypervisor that facilitates creation of multiple virtual storage servers on a host computing device on which the hypervisor is executing. The cloud can host multiple data storage appliances and at least some of the data storage appliances can have their own primary caches. Further, at least some of the data storage appliances can share the same cache cluster of the cloud as their victim cache.

Some of the advantages of the technology include:

(a) Scalability—Cache nodes can be added in the cache cluster or removed from the cluster on-need basis, hence elastic, scalable and cost-efficient. Since the cache cluster nodes can be instantiated on-need basis and hence, the resources can be utilized efficiently with optimum costs;

(b) Minimum-to-Zero cache warming time—Since the cache nodes are persistent, the data in the victim cache is not lost upon a crash of the data storage appliance unlike in the case of the primary cache of the data storage appliance, thereby requiring minimum to no time to warm the primary cache after the data storage appliance is up; and

(c) Reliability—The data in the cache cluster can be replicated from one cache node to one or more other cache nodes in the cache cluster. The replication feature of the cache cluster services may even be leveraged to provide rapid availability in different regions in the event of disaster in one of the regions.

### Environment

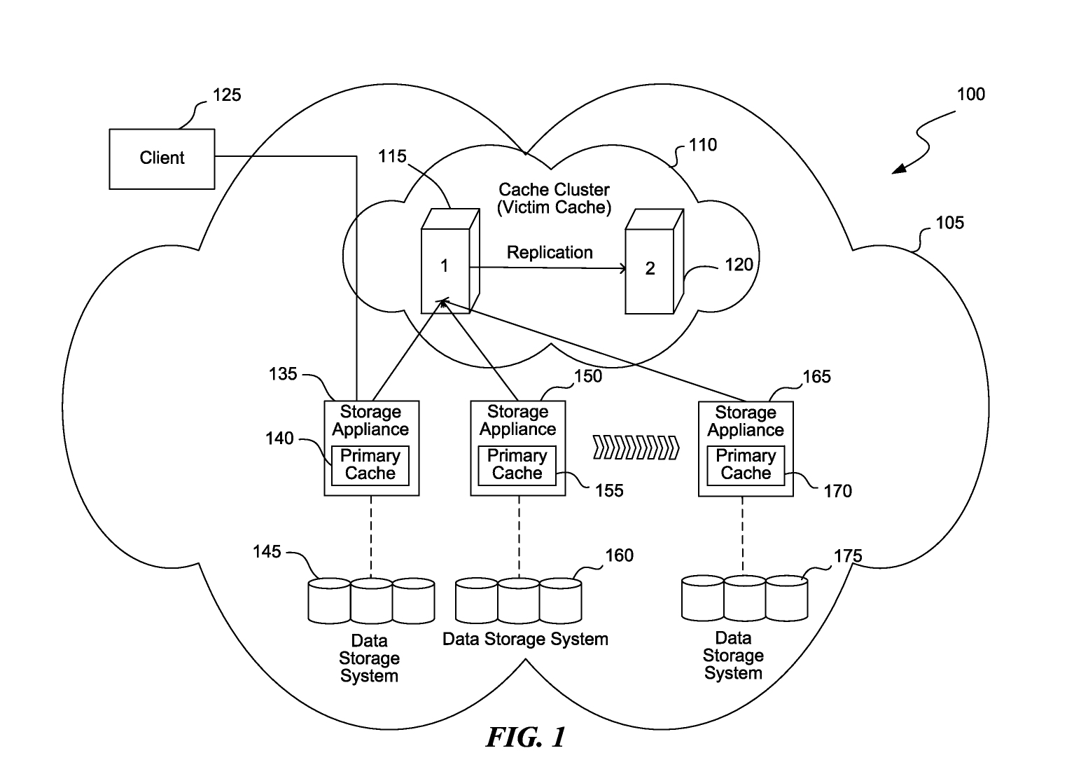

FIG. 1 is a block diagram illustrating an environment 100 in which the disclosed embodiments of a data storage appliance can be implemented. The environment 100 includes a cloud computing service, e.g., cloud computing service 105, in which the data storage appliance, e.g., a first data storage appliance 135, can be implemented to provide data storage services for a client, e.g., client 125. As described above, the cloud 105 can provide infrastructure, e.g., hardware and/or software resources, to implement one or more applications, products and/or services, e.g., data storage appliances 135, 150 and 165. The data storage appliances can be implemented by one entity and the cloud 105 can be provided and/or managed by another entity. For example, the first data storage appliance 135 can be a Network File System (NFS) file server commercialized by NetApp of Sunnyvale, Calif., that uses various storage operating systems, including the NetApp® Data ONTAP-v™ and the cloud 105 can be Amazon Elastic Compute Cloud (Amazon EC2) provided by Amazon of Seattle, Wash.

A data storage appliance can be implemented as a virtual storage appliance. For example, the first data storage appliance 135 is a virtual storage appliance. A virtual storage appliance executes on a host computing device (referred to as “host”) provided by the cloud 105. The host can include a hypervisor which facilitates executing one or more virtual storage appliances on the host. In some embodiments, the cloud 105 includes multiple hosts each of which is capable of executing one or more data storage appliances. In some embodiments, in addition to the data storage appliances 135, 150 and 165, some of the hosts execute other services, e.g., a video streaming service that streams video to users on-demand.

The data storage appliances provide data storage services to clients. For example, the first data storage appliance 135 can service read and/or write requests from the client 125. The first data storage appliance 135 stores the data, e.g., data received from the client 125, in a persistent storage medium, e.g., a first data storage system 145, associated with the first data storage appliance 135. In some embodiments, the persistent storage medium can include storage media such as hard disk drives (HDD), magnetic tapes, optical disks such as CD-ROM or DVD-based storage, magneto-optical (MO) storage, or any other type of non-volatile storage devices suitable for storing large quantities of data.

The first data storage appliance 135 includes a primary cache 140 that can cache a portion of the data stored at the first data storage system 145. In some embodiments, the primary cache 140 can be a random access memory (RAM) based storage medium, e.g., dynamic RAM (DRAM). Typically, a read latency (e.g., time consumed for retrieving the requested data from a storage medium) of the primary cache 140 is lower than that of the first data storage system 145 and therefore, obtaining data from the primary cache 140 is faster than obtaining from the first data storage system 145. So when a read request is received from the client 125, the first data storage appliance 135 can retrieve the requested data from the primary cache 140 instead of the first data storage system 145. In an event that the requested data is not available at the primary cache 140, the first data storage appliance 135 can obtain the requested data from the first data storage system 145.

In some embodiments, the first data storage appliance 135 uses a cache cluster 110 of the cloud 105 as a secondary cache or a victim cache to store the data evicted from the primary cache 140. When a set of data is evicted from the primary cache 140, e.g., because there is not enough storage space in the primary cache 140 to store the incoming data from the client 125, instead of deleting the set of data from the primary cache 140, the set of data can be copied to the cache cluster 110 and then deleted from the primary cache 140. This way, a future read request from the client 125 for the set of data can be serviced by obtaining the set of data from the cache cluster 110 instead of from the first data storage system 145, thereby decreasing the time consumed in obtaining the requested data and improving the read throughput of the first data storage appliance 135. The cache cluster 110 can act as a storage layer that is logically between the primary cache 140 and the first data storage system 145. In an event the requested data is not available at the cache cluster 110, the first data storage appliance 135 can then obtain the requested data from the first data storage system 145. Typically, the read latency of the cache cluster 110 is lower than that of the first data storage system 145, and therefore obtaining the data from the cache cluster 110 is faster than that of obtaining from the first data storage system 145. In some embodiments, the cache cluster 110 can store the data using flash-based storage devices, e.g., SSDs, non-volatile, solid-state NAND flash devices which are block-oriented devices having good (random) read performance, i.e., read operations to flash devices are substantially faster than write operations.

In some embodiments, the cache cluster 110 acts as a primary cache of the cloud 105, e.g., the cloud 105 uses the cache cluster 110 to cache data that is associated with the cloud 105 and/or any other services that are implemented in the cloud 105. By leveraging the cache cluster 110 of the cloud 105 as a victim cache for the first data storage appliance 135, the amount of time required to serve a read request, at least for a subset of the data at the first data storage system 145 that is stored in the cache cluster 110, can be decreased significantly as the time taken to retrieve the requested data from the cache cluster 110 is lesser than that of retrieving from the first data storage system 145. Therefore, the performance of the first data storage appliance 135 can be improved and the I/O throughput can be increased by using the cache cluster 110 of the cloud 105 as a victim cache for the first data storage appliance 135.

The cache cluster 110 includes a number of cache nodes, e.g., a first cache node 115 and a second cache node 120. In some embodiments, each of the cache nodes can have an associated set of storage devices (not illustrated) to store the data, e.g., data evicted from the primary cache 140. Further, data stored at one cache node can be replicated to one or more other cache nodes in the cache cluster 110, e.g., to improve data reliability. For example, data stored at the first cache node 115 can be replicated to the second cache node 120. In some embodiments, different cache nodes of the cache cluster 110 can be physically located in different geographical regions. In some embodiments, a cache node in the cache cluster 110 can be instantiated on-need basis or per a service level agreement (SLA) between a provider of the cloud 105 and a consumer of the cloud 105. For example, if the SLA indicates that data beyond a specified amount is to be stored in the cache cluster 110 or a specified read throughput is to be provided, the number of cache nodes in the cache cluster 110 can be increased or decreased accordingly by instantiating more cache nodes or terminating existing instances of the cache nodes, respectively.

As described above, multiple data storage appliances can be implemented in the cloud 105. Each of the data storage appliances can have an associated primary cache and an associated persistent storage medium. For example, the second data storage appliance 150 can have an associated primary cache 155 and an associated second data storage system 160. Similarly, the third data storage appliance 165 can have an associated primary cache 170 and an associated second data storage system 175. In some embodiments, some or all of the data storage appliances in the cloud 105 use the cache cluster 110 as a victim cache for the corresponding data storage appliance. That is, while at least some of the data storage appliances each have their own primary caches, their victim cache is in the same cache cluster 110 of the cloud 105. The data storage appliances can communicate with the cache cluster via a communication network, e.g., intranet, Internet, local area network (LAN), wide area network (WAN).

The first data storage appliance 135 can be a block-based storage system that stores data as blocks or an object-based storage system that stores data as objects. An example of a block-based storage appliance includes NFS file servers provided by NetApp of Sunnyvale, Calif. In some embodiments, the block-based data storage system organizes data files using inodes. An inode is a data structure that has metadata of the file and locations of the data blocks (also referred to as “data extents”) that store the file data. The inode has associated inode identification (ID) that uniquely identifies the file. A data extent also has an associated data extent ID that uniquely identifies the data extent. Each of the data extents in the inode is identified using a file block number. The files are accessed by referring to the inodes of the files. The files can be stored in a multi-level hierarchy, e.g., in a directory within a directory.

An example of an object-based storage system can includes a cloud storage service such as S3 from Amazon of Seattle, Wash., Microsoft Azure from Microsoft of Redmond, Wash. In some embodiments, the object-based data storage appliance can have a flat file system that stores the data objects in a same hierarchy. For example, the data objects are stored in an object container, and the object container may not store another object container in it. All the data objects for a particular object container can be stored in the object container in the same hierarchy.

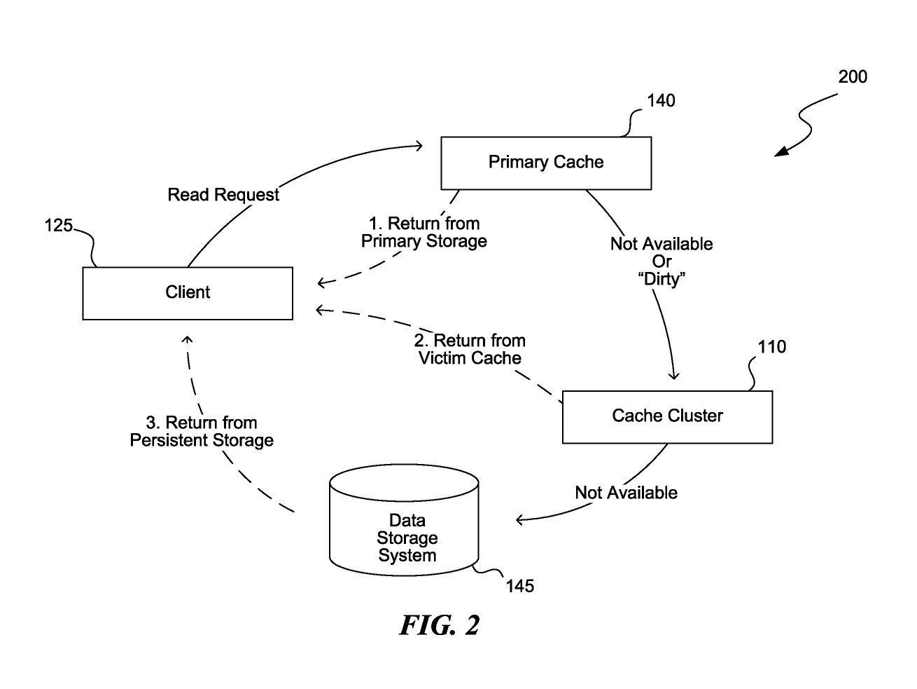

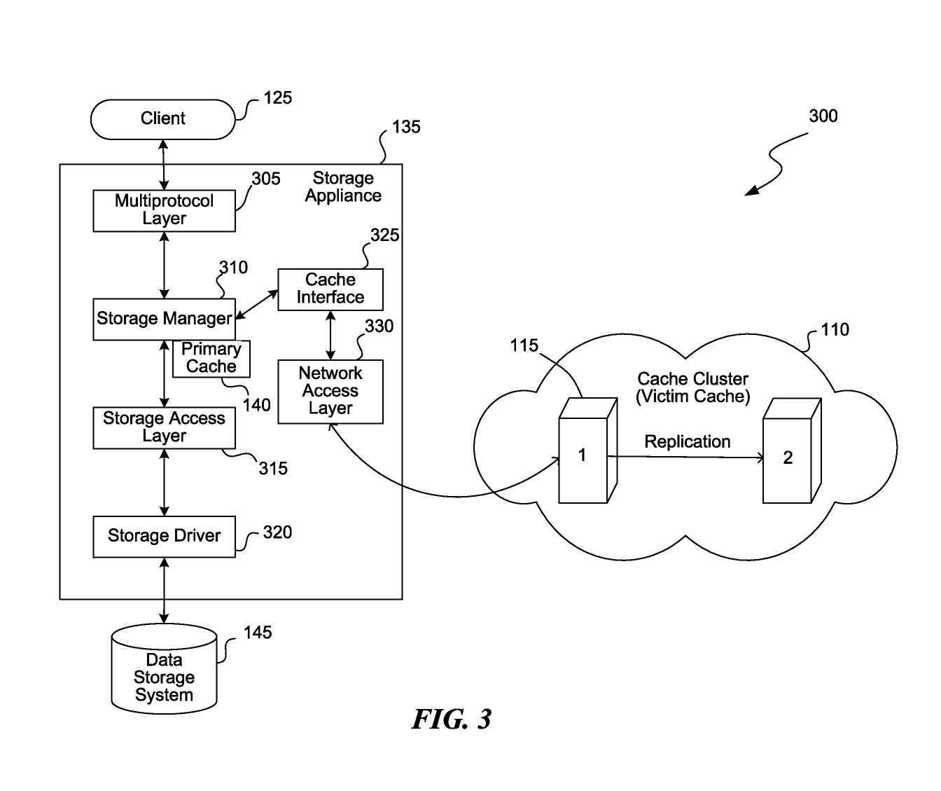

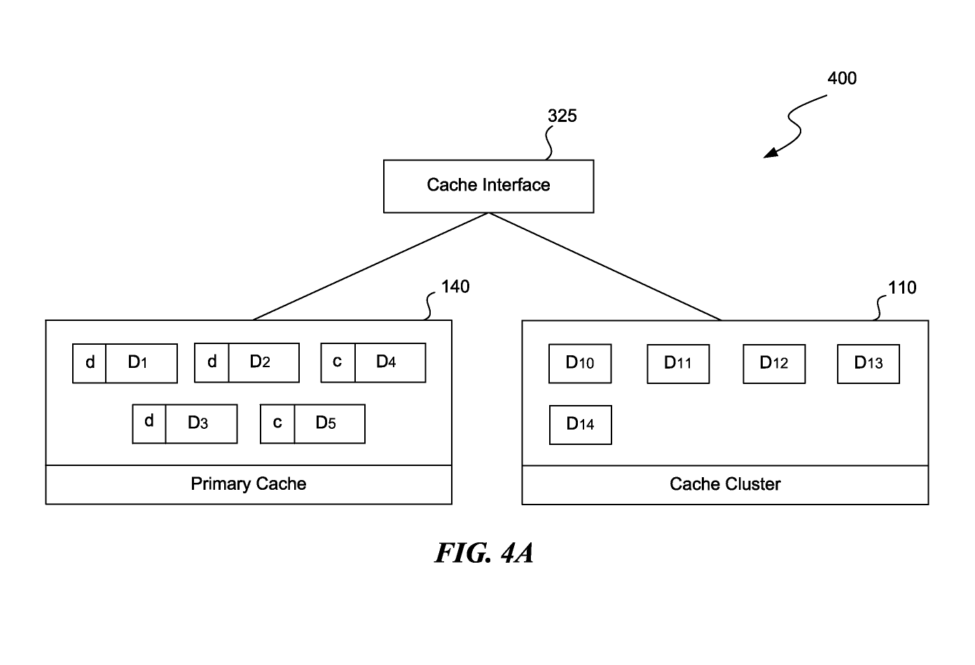

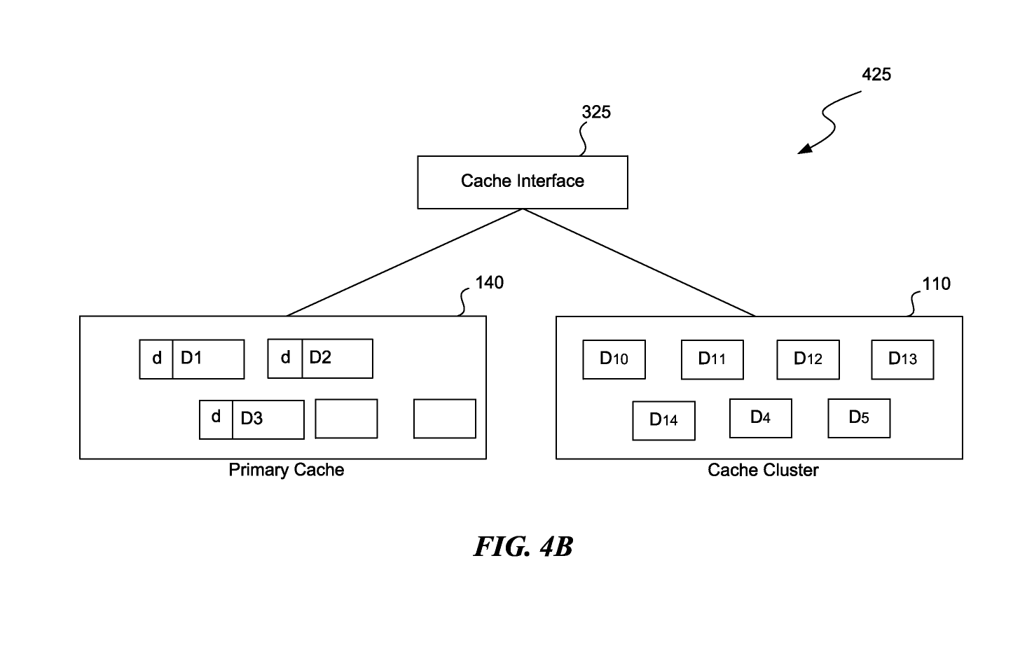

FIG. 2 is a block diagram illustrating an example of processing a read request using the data storage appliance of FIG. 1, consistent with various embodiments. In the example 200, a client, e.g., client 125 issues a read request to a data storage appliance, e.g., the first data storage appliance 135, for obtaining a set of data. The first data storage appliance 135 determines if the set of data is available at the primary cache 140 and not marked as “dirty.” In some embodiments, data is marked as “dirty” if the data is not yet stored in a persistent storage medium associated a data storage appliance, e.g., at the first data storage system 145. Additional details with respect to marking the data as “dirty” and/or “clean” is described at least with respect to FIGS. 3 and 4A and 4B.

If the set of data is available and not marked as dirty, the first data storage appliance 135 can retrieve the set of data from the primary cache 140 and return the set of data to the client 125. In an event the set of data is not available at the primary cache 140, the first data storage appliance 135 determines the set of data is available at the cache cluster 110. The likelihood of the cache cluster 110 having the set of data is high since the first data storage appliance 135 stores the data evicted from the primary cache 140 in its victim cache, e.g., the cache cluster 110. If the set of data is available at the cache cluster 110, the first data storage appliance 135 retrieves the set of data from the cache cluster 110 and returns the set of data to the client 125, thereby avoiding a read operation on the first data storage system 145, which can consume more time to obtain the set of data as the first data storage system 145 can have a higher read latency than the cache cluster 110. In an event the set of data is not available at the cache cluster 110, the first data storage appliance 135 can obtain the requested data from the first data storage system 145 and return the set of data to the client 125.

As can be appreciated, the introduction of cache cluster 110 as the victim cache for the first data storage appliance 135 can minimize the amount of time consumed in serving a read request from the client 125. Since the time for responding to a request is decreased, with the saved computing resources, the first data storage appliance 135 can process more number of read requests and/or use the resources to process more write requests, thereby increasing the I/O throughput of the first data storage appliance 135.

FIG. 3 is a block diagram of an architecture 300 of a data storage appliance implemented in the cloud of FIG. 1, consistent with various embodiments. The first data storage appliance 135 processes read and/or write requests from the client 125. The first data storage appliance 135 manages the storage of data in the cloud 105—reading from and/or writing data into the first data storage system 145, evicting data from the primary cache 140, populating the victim cache with the evicted data etc.

The blocks in the first data storage appliance 135 can be generally representative of a storage operating system in the first data storage appliance 135. As shown, the storage operating system includes several software modules, or “layers”. These layers include a multiprotocol layer 305, a storage manager 310, a storage access layer 315, a storage driver 320 and a cache interface 325. The storage manager 310 is, in some embodiments, software, which imposes a structure (e.g., a hierarchy) on the data stored in the first data storage system 145. For example, the storage manager 310 can store the data as data blocks in the first data storage system 145.

To allow the first data storage appliance 135 to communicate over the network (e.g., with client 125 or cache cluster 110), the storage operating system also includes a multiprotocol layer 305 and a network access layer 330. The multiprotocol layer 305 implements various higher-level network protocols, such as NFS, Common Internet File System (CIFS), Hypertext Transfer Protocol (HTTP), user datagram protocol (UDP) and Transmission Control Protocol/Internet Protocol (TCP/IP). The network access layer 330 includes one or more network drivers that implement one or more lower-level protocols to communicate over the network, such as Ethernet, Fibre Channel, InfiniBand or Internet small computer system interface (iSCSI).

The storage access layer 315 and the storage driver 320 allow the first data storage appliance 135 to communicate with the first data storage system 145. The storage access layer 315 can implement a higher-level storage redundancy algorithm, such as RAID-3, RAID-4, RAID-5, RAID-6 or RAID-DP. The storage driver 320 implements a lower-level protocol to allow access to the first data storage system 145.

When the client 125 issues a write request for writing a set of data, the multiprotocol layer 305 processes the request based on the protocol using which the client 125 issued the request, and forwards the set of data to the storage manager 310. The storage manager 310 writes the set of data to the primary cache 140 and marks the set of data as dirty. If write request is for updating an existing set of data, the storage manager 310 updates the existing set of data in the primary cache 140 and marks the set of data as dirty. After the set of data is written into the primary cache 140, the first data storage appliance 135 acknowledges the client 125 of a successful write operation.

The storage manager 310 writes the data stored in the primary cache 140 to the first data storage system 145, e.g., upon a trigger. The trigger can be an occurrence of an event, e.g., available storage capacity in the primary cache 140 dropping below a specified threshold, expiration of a time interval since the last write to the first data storage system 145. Upon the occurrence of the trigger, the storage manager 310 identifies the data that is marked dirty and writes the data to the first data storage system 145. The storage access layer 315 can determine the location in the first data storage system 145 where the data has to be stored and writes the data using the storage driver 320. After the data is written to the first data storage system 145, the storage manager 310 marks the data in the primary cache 140 as clean indicating that the data is written to the first data storage system 145.

When the data is evicted from the primary cache 140, the cache cluster 110 can be populated with evicted data. Data can be evicted from the primary cache 140 for various reasons, e.g., to store new incoming data from the client 125. The first data storage appliance 135 can evict the data upon a trigger, e.g., available storage capacity in the primary cache 140 dropping below a specified threshold, expiration of a time interval since the last eviction. Upon the occurrence of the trigger, the cache interface 325 identifies a set of data marked as clean in the primary cache 140 and copies the set of data marked as clean to the cache cluster 110, e.g., to the first cache node 115. After the set of data is copied to the cache cluster 110, the set of data is deleted from the primary cache 140. The cache interface 325 transmits the set of data to the cache cluster 110 using the network access layer 330, which facilitates transmission of the set of data as per the network protocol of a network over which the first data storage appliance 135 communicates with the cache cluster 110.

In some embodiments, the cache interface 325 evicts only the data marked as clean, as the clean data is already stored in the first data storage system 145. The cache interface 325 may not evict the data marked as dirty in the primary cache as the dirty data is not yet written to the first data storage system 145.

FIGS. 4A and 4B are block diagrams illustrating a process of data eviction in the data storage appliance of FIG. 1, consistent with various embodiments. FIG. 4A is a block diagram of example 400 illustrating the primary cache 140 and the cache cluster 110 before data is evicted from the primary cache 140. In some embodiments, the set of data marked “d,” e.g., D1, D2 and D3, are dirty data. In some embodiments, the set of data marked “c,” e.g., D4 and D5, are clean data.

As described above, the cache interface 325 examines the primary cache 140, e.g., upon the occurrence of a trigger to perform data eviction, to identify a set of data marked as clean in the primary cache 140. For example, the cache trigger identifies data “D4” and “D5” marked as clean, as shown in the example 400. The cache interface 325 then copies the clean data, e.g., “D4” and “D5,” to the cache cluster 110, as illustrated in the example 425 of FIG. 4B. After the clean data is copied to the cache cluster 110, the clean data is deleted from the primary cache 140.

The cache cluster 110 can store the evicted data in a cache node, e.g., the first cache node 115. In some embodiments, the contents of the first cache node 115 are replicated to the second cache node 120, e.g., to improve data reliability, to serve clients in different geographical regions, load balancing of read requests on the cache nodes. Further, the cache nodes in the cache cluster can be added or removed dynamically, e.g., on-need basis. For example, the second cache node 120 can be dynamically added to the cache cluster 110 by instantiating an instance of the second cache node 120, e.g., when the number of read requests exceeds a specified threshold. Similarly, the second cache node 120 can be dynamically removed from the cache cluster 110 by terminating the instance of the second cache node, e.g., when the number of read requests is below a specified threshold.

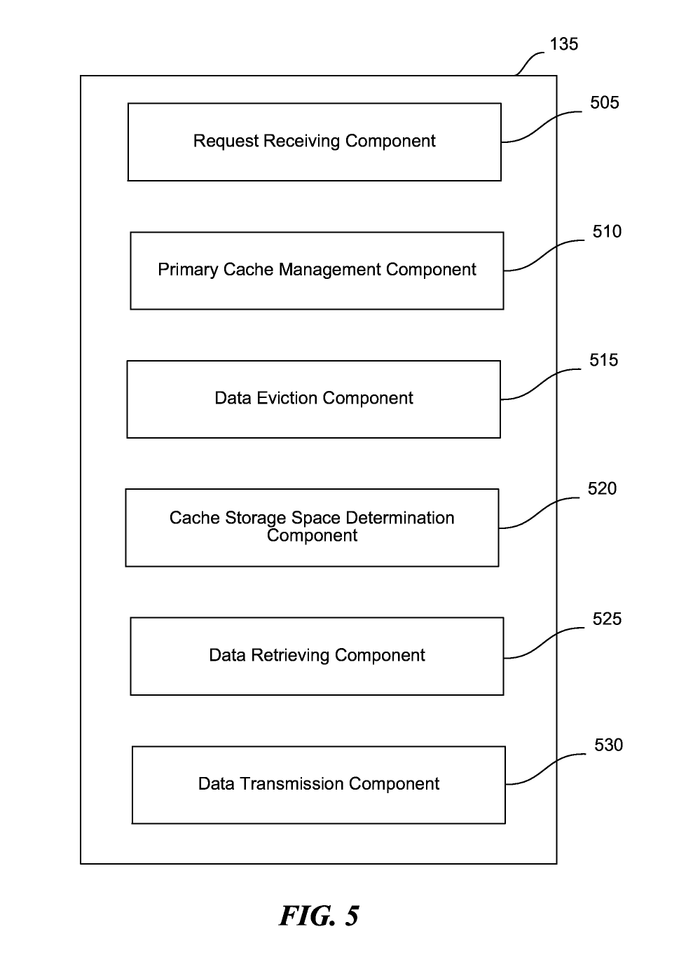

FIG. 5 is a block diagram of the data storage appliance of FIG. 1, consistent with various embodiments. The first data storage appliance 135 includes a request receiving component 505 that can receive data requests from clients. For example, the receiving component can receive read and/or write requests from the client 125. The first data storage appliance 135 includes a primary cache management component 510 can perform data management in the primary cache 140. For example, the primary cache management component 510 can write data into the primary cache 140, write data from the primary cache 140 to the first data storage system 145, marking the data dirty or clean, etc.

The first data storage appliance 135 includes a cache storage space determination component 520 that perform cache storage space management operations, e.g., determining whether the available storage space in the primary cache is below a specified threshold, notifying a data eviction component 515 on low availability of storage space. The data eviction component 515 can evict data from a primary cache to the victim cache of the data storage appliance. For example, the data eviction component 515 can evict the clean data from the primary cache 140 to the victim cache, e.g., cache cluster 110, of the first data storage appliance 135.

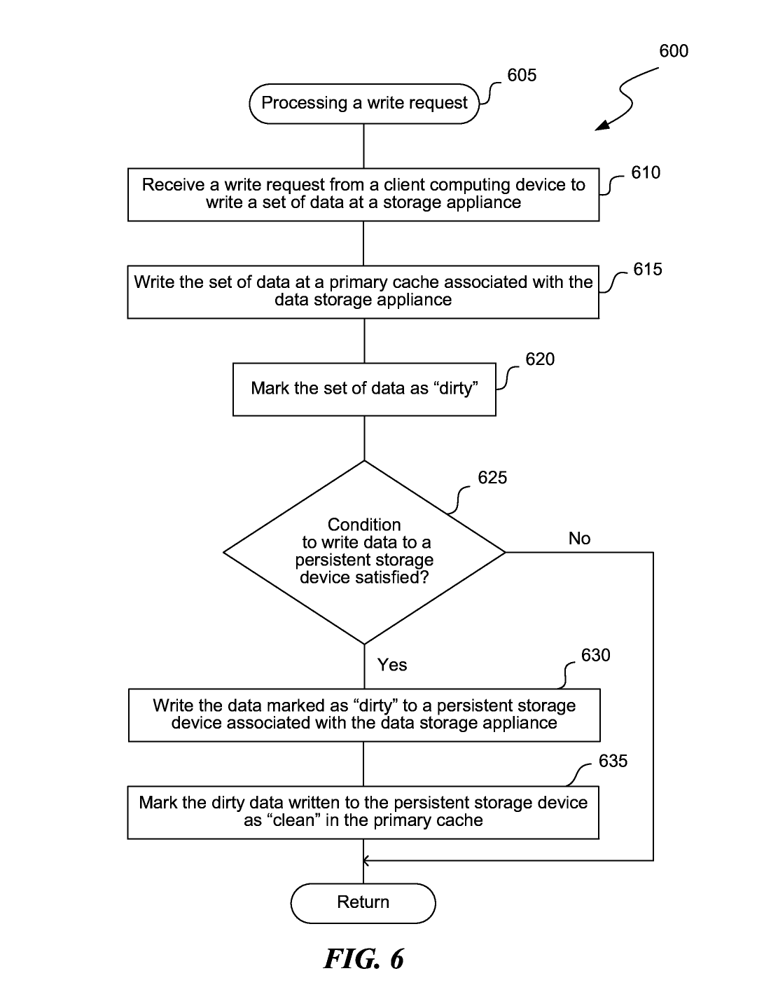

The first data storage appliance 135 includes a data retrieving component 525 to retrieve data from one or more of the primary cache 140, the cache cluster 110, or the first data storage system 145. The data transmission component 530 can transmit the data e.g., data retrieved from one or more of the primary cache 140, the cache cluster 110, or the first data storage system 145, to the clients, e.g., client 125. The components 505-530 are used to perform the functions of the first data storage appliance 135 described at least with reference to FIG. 1 and FIG. 3. Additional details regarding the above components are described at least with reference to FIGS. 6-8 below.

Note that the other data storage appliances in the cloud 105 can have components similar to that of the first data storage appliance 135 described above. In some embodiments, one or more of the above components 505-530 are implemented in addition to the blocks 305-330 of the first data storage appliance 135 described at least with reference to FIG. 3. In some embodiments, one or more of the above components 505-530 are implemented as part of one or more of the blocks 305-330.

FIG. 6 is a flow diagram a process 600 of writing data to a data storage appliance implemented in a cloud of FIG. 1, consistent with various embodiments. In some embodiments, the process 600 may be implemented in environment 100 of FIG. 1. The process 600 begins at block 605, and at block 610, the request receiving component 505 receives a write request from a client, e.g., client 125, to write a set of data at a data storage appliance, e.g., the first data storage appliance 135.

At block 615, the primary cache management component 510 writes the set of data at a primary cache associated with the first data storage appliance 135, e.g., the primary cache 140.

At block 620, the primary cache management component 510 marks the set of data as dirty indicating that the set of data is not stored in a persistent storage medium associated with the first data storage appliance 135, e.g., the first data storage system 145.

At determination block 625, the primary cache management component 510 determines whether a condition to write the set of data to the first data storage system 145 is satisfied. The condition can be based on a trigger, e.g., occurrence of an event, available storage capacity in the primary cache 140 dropping below a specified threshold, expiration of a time interval since the last write to the first data storage system 145. In some embodiments, the primary cache management component 510 coordinates with the cache storage space determination component 520 to determine whether the available storage capacity in the primary cache 140 has dropped below a specified threshold.

If the condition is satisfied, at block 630, the primary cache management component 510 identifies the data that is marked as dirty and writes the data to the first data storage system 145. On the other hand, if the condition is not satisfied, the process 600 returns.

At block 635, after the data is written to the first data storage system 145, the primary cache management component 510 marks the data in the primary cache 140 as clean indicating that the data is written to the first data storage system 145.

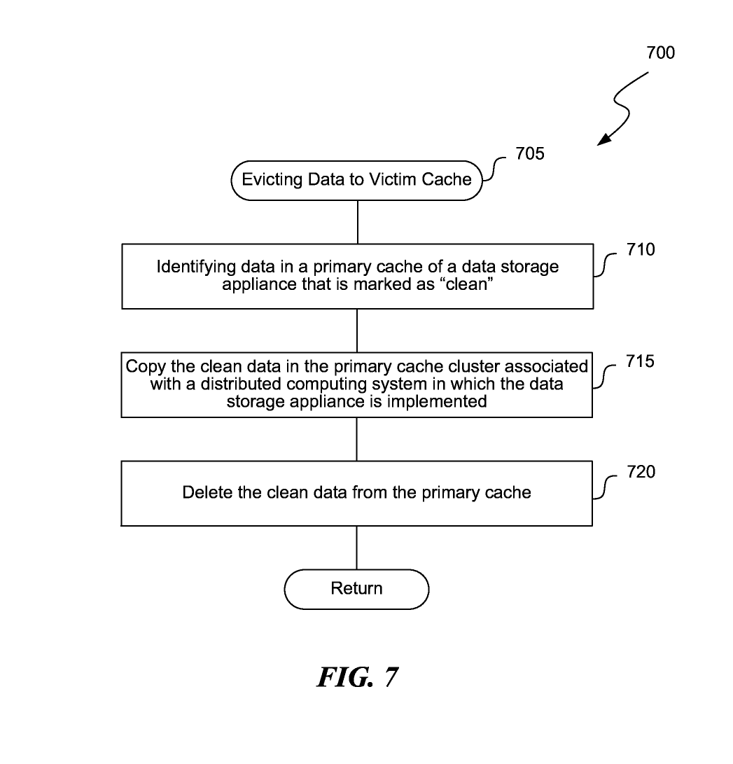

FIG. 7 is a flow diagram of a process 700 for evicting data from a primary cache to a victim cache of a data storage appliance in a cloud of FIG. 1, consistent with various embodiments. In some embodiments, the process 700 may be implemented in environment 100 of FIG. 1. The process 700 begins at block 705, and at block 710, the data eviction component 515 identifies the data that is marked as clean in a primary cache of a data storage appliance. For example, the data eviction component 515 identifies the data that is marked as clean in the primary cache 140 of the first data storage appliance 135. Data can be evicted from the primary cache 140 for various reasons, e.g., to store new incoming data from the client 125. The first data storage appliance 135 can evict the data upon a trigger, e.g., available storage capacity in the primary cache 140 dropping below a specified threshold, expiration of a time interval since the last eviction.

At block 715, the data eviction component 515 copies the set of data marked as clean to a victim cache of the first data storage appliance 135, e.g., the cache cluster 110 of the cloud 105. In some embodiments, the data is copied to a cache node of the cache cluster, e.g., the first cache node 115.

After the set of data is copied to the cache cluster 110, at block 720, the data eviction component 515 deletes the set of data from the primary cache 140. In some embodiments, the data eviction component 515 evicts only the data marked as clean, as clean data is the data that is already stored in the first data storage system 145. The data eviction component 515 may not evict the data marked as dirty in the primary cache 140 as the dirty data is not yet written to the first data storage system 145.

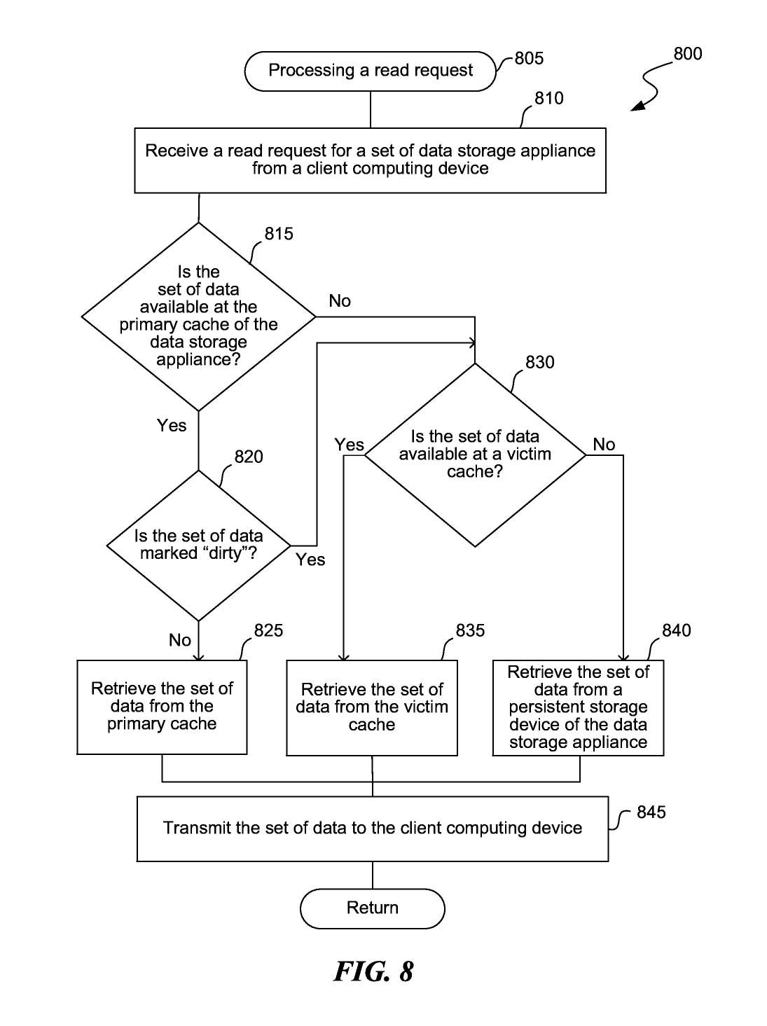

FIG. 8 is a flow diagram of a process 800 for reading data from a data storage appliance in a cloud of FIG. 1, consistent with various embodiments. In some embodiments, the process 800 may be implemented in environment 100 of FIG. 1. The process 800 begins at block 805, and at block 810, the request receiving component 505 receives a read request from a client for retrieving a set of data from a data storage appliance, e.g., the first data storage appliance 135. At determination block 815, the data retrieving component 525 determines if the set of data is available in the primary cache 140 of the first data storage appliance 135.

If the set of data is available at the primary cache 140, at determination block 820, the data retrieving component 525 determines if the set of data is marked as dirty. If the data is not marked as dirty, at block 825, the data retrieving component 525 retrieves the set of data from the primary cache 140. In an event the set of data is not available at the primary cache 140 and/or if the set of data is marked as dirty, at determination block 830, the data retrieving component 525 determines if the set of data is available at a victim cache of the first data storage appliance 135, e.g., the cache cluster 110 of the cloud 105.

If the set of data is available at the cache cluster 110, at block 835, the data retrieving component 525 retrieves the set of data from the cache cluster 110, e.g., from the first cache node 115 of the cache cluster 110. In an event the set of data is not available at the cache cluster 110, at block 840, the data retrieving component 525 obtains the set of data from the first data storage system 145.

At block 845, the data transmission component 530 returns the set of data to the client 125, and the process 800 returns. As can be appreciated, the introduction of cache cluster 110 as the victim cache for the first data storage appliance 135 can minimize the amount of time consumed in serving a read request from the client 125. As the time for responding to a request is decreased, with the saved computing resources, the first data storage appliance 135 can process more number of read requests and/or use the resources to process more write requests, thereby increasing the I/O throughput of the first data storage appliance 135.

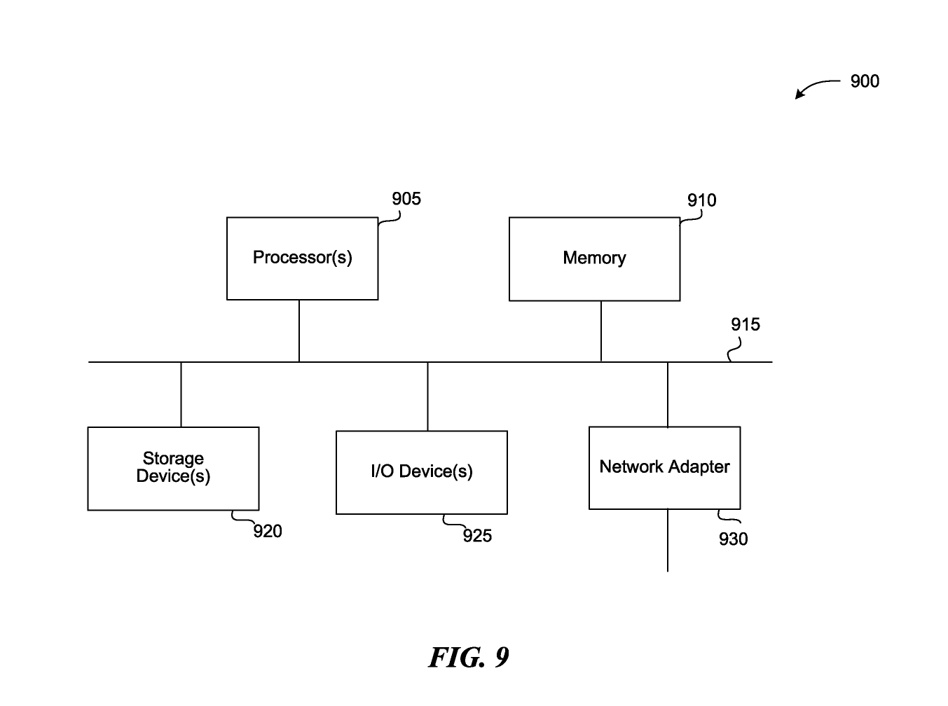

FIG. 9 is a block diagram of a computer system as may be used to implement features of some embodiments of the disclosed technology. The computing system 900 may be used to implement any of the entities, components or services depicted in the examples of FIGS. 1-8 (and any other components described in this specification). The computing system 900 may include one or more central processing units (“processors”) 905, memory 910, input/output devices 925 (e.g., keyboard and pointing devices, display devices), storage devices 920 (e.g., disk drives), and network adapters 930 (e.g., network interfaces) that are connected to an interconnect 915. The interconnect 915 is illustrated as an abstraction that represents any one or more separate physical buses, point to point connections, or both connected by appropriate bridges, adapters, or controllers. The interconnect 915, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 910 and storage devices 920 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 910 can be implemented as software and/or firmware to program the processor(s) 905 to carry out actions described above. In some embodiments, such software or firmware may be initially provided to the computing system 900 by downloading it from a remote system through the computing system 900 (e.g., via network adapter 930).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Some terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/We claim:

1. A computer-implemented method, comprising:
receiving a set of data from a client computing device at a data storage appliance executing in a distributed computing system;
confirming by the data storage appliance that a storage space in a primary cache associated with the data storage appliance is below a threshold;
identifying data that is marked as clean data in the primary cache, the clean data being a portion of the data in the primary cache that is marked as the clean data if the portion of the data is stored at a persistent storage device associated with the data storage appliance;
evicting the clean data from the primary cache to a cache node of a cache cluster associated with the distributed computing system, the cache cluster acting as a victim cache for the data storage appliance; and
storing the set of data at the primary cache.

2. The computer-implemented method of claim 1 further comprising:
receiving a read request from the client computing device at the data storage appliance for a first set of data;
determining, by the data storage appliance, if the first set of data is stored at the primary cache;
responsive to a determination that the first set of data is not available at the primary cache, retrieving the first set of data from the victim cache; and
transmitting the first set of data to the client computing device.

3. The computer-implemented method of claim 2, wherein retrieving the first set of data from the victim cache includes:
determining, by the data storage appliance, if the first set of data is stored at the victim cache; and
responsive to a determination that the first set of data is not stored at the victim cache, retrieving the first set of data from the persistent storage device.

4. The computer-implemented method of claim 1, wherein the data storage appliance is a virtual data storage server executing on a hypervisor in the distributed computing system.

5. The computer-implemented method of claim 1, wherein the data storage appliance is one of multiple data storage appliances executing in the distributed computing system, wherein each of at least some of the data storage appliances has a corresponding primary cache.

6. The computer-implemented method of claim 1, wherein evicting the clean data includes evicting a portion of data marked as clean in the primary caches of the at least some of the data storage appliances to the victim cache.

7. The computer-implemented method of claim 1, wherein evicting the clean data from the primary cache to the cache node further includes:
replicating data stored in the cache node to one or more of multiple cache nodes in the cache cluster.

8. The computer-implemented method of claim 7, wherein replicating the data to the one or more of the cache nodes includes:
determining based on a trigger condition that a second cache node of the cache nodes is needed to store the clean data evicted from the primary cache; and
adding the second cache node to the cache cluster by instantiating an instance of the second cache node.

9. The computer-implemented method of claim 8 further comprising:
determining based on a trigger condition that an available storage capacity at the cache cluster exceeds a specified threshold; and
removing the second cache node from the cache cluster by terminating the instance of the second cache node.

10. The computer-implemented method of claim 1 further comprising:
marking the set of data at the primary cache as dirty data.

11. The computer-implemented method of claim 10 further comprising:
storing, in response to a trigger condition, the set of data stored at the primary cache at the persistent storage device associated with the data storage appliance; and
marking, in response to storing the set of data at the persistent storage device, the set of data in the primary cache as the clean data.

12. A computer-readable storage medium storing computer-executable instructions comprising:
instructions for receiving, from a client computing device, a request for retrieving a set of data stored at a data storage appliance in a distributed computing system, the data storage appliance including a primary cache that stores at least a portion of data managed by the data storage appliance, the distributed computing system including a cache cluster that stores at least a portion of data managed by multiple data storage appliances;
instructions for determining by the data storage appliance whether the set of data is stored at a primary cache associated with the data storage appliance;
instructions for retrieving, responsive to a determination that the set of data is not available at the primary cache, the set of data from the cache cluster of the distributed computing system, the cache cluster acting as a victim cache for the data storage appliance and storing a portion of the data evicted from the primary cache; and
instructions for transmitting the set of data to the client computing device.

13. The computer-readable storage medium of claim 12, wherein the instructions for retrieving the set of data from the victim cache includes:
instructions for determining, by the data storage appliance, if the set of data is stored at the victim cache; and
instructions for retrieving, responsive to a determination that the first set of data is not stored at the victim cache, the set of data from a persistent storage device associated with the data storage appliance.

14. The computer-readable storage medium of claim 12, wherein the instructions for storing a portion of the data evicted from the primary cache at the victim includes:
instructions for determining whether the portion of the data is marked as clean data, the portion of the data being marked as the clean data if the portion of the data is stored at a persistent storage device associated with the data storage appliance; and
instructions for evicting the clean data from the primary cache to the victim cache.

15. The computer-readable storage medium of claim 14, wherein each of at least some of the data storage appliances has a corresponding primary cache.

16. The computer-readable storage medium of claim 15, wherein evicting the clean data includes evicting a portion of data marked as clean in the primary caches of the at least some of the data storage appliances to the victim cache.

17. The computer-readable storage medium of claim 14, wherein evicting the clean data from the primary cache to the victim cache further includes:
instructions for replicating data stored in the cache node to one or more of multiple cache nodes in the cache cluster.

18. The computer-readable storage medium of claim 12 further comprising:
instructions for receiving a first set of data from the client computing device to be stored at the data storage appliance;
instructions for storing the first set of data at the primary cache; and
instructions for marking the first set of data as dirty data.

19. The computer-readable storage medium of claim 18 further comprising:
instructions for identifying, in response to a trigger condition, the dirty data stored at the primary cache;
instructions for storing the dirty data at a persistent storage device associated with the data storage appliance; and
instructions for marking, in response to the storing, the dirty data in the primary cache as clean data.

20. The computer-readable storage medium of claim 18 further comprising:
instructions for confirming by the data storage appliance that a storage space in the primary cache is below a specified threshold;
instructions for identifying data that is marked as clean data in the primary cache; and
instructions for evicting the clean data from the primary cache to the victim cache for the data storage appliance.

21. A system comprising:
a processor;
a first component configured to receive a set of data from a client computing device at a data storage appliance executing in a distributed computing system;
a second component configured to confirm that a storage space in a primary cache associated with the data storage appliance is below a threshold;
a third component configured to identify data that is marked as clean data in the primary cache, the clean data being a portion of the data in the primary cache that is marked as the clean data if the portion of the data is stored at a persistent storage device associated with the data storage appliance;
a fourth component to evict the clean data from the primary cache to a cache node of a cache cluster associated with the distributed computing system, the cache cluster acting as a victim cache for the data storage appliance; and
a fifth component to store the set of data at the primary cache.

22. The system of claim 21, wherein the first component is further configured to receive a read request for a first set of data stored at the data storage appliance, and wherein the system further comprises:
a sixth component configured to:
determine if the first set of data is stored at the primary cache, and
responsive to a determination that the first set of data is not available at the primary cache, retrieve the first set of data from the victim cache, and
a seventh component to transmit the first set of data to the client computing device.

23. The system of claim 22, wherein the sixth component is further configured to: determine if the first set of data is stored at the victim cache, and
responsive to a determination that the first set of data is not stored at the victim cache, retrieve the first set of data from the persistent storage device.

24. The system of claim 21, wherein the data storage appliance is a virtual data storage server executing on a hypervisor in the distributed computing system.

25. The system of claim 21, wherein the fifth component is further configured to mark the set of data at the primary cache as dirty data.

26. The system of claim 25, wherein the fifth component is further configured to:
store, in response to a trigger condition, data that is marked as dirty data in the primary cache at the persistent storage device, and
mark, in response to storing the set of data at the persistent storage device, the set of data in the primary cache as the clean data.
